(19) United States
(12) Patent Application Publication
(10) Pub. No.: US 2008/0270540 A1
(43) Pub. Date: Oct. 30, 2008

(54) Filter and a Method of Filtering Electronic Messages

(76) Inventor: Martin Wahlers Larsen, Tentlingen (CH)

Correspondence Address: HARNESS, DICKEY & PIERCE, P.L.C., P.O. BOX 8910, RESTON, VA, 20195, US

(21) Appl. No.: 10/594,888

(22) PCT Filed: Mar. 30, 2005
(86) PCT No.: PCT/DK2005/000219

§ 371 Date: May 7, 2008

Related U.S. Application Data
(60) Provisional application No. 60/557,405, filed on Mar. 30, 2004.

(30) Foreign Application Priority Data
Mar. 30, 2004 (DK) PA 2004 00508

(51) Int. Cl. G06F 15/16

(52) U.S. Cl. 709/206

(57) ABSTRACT

The invention provides a filter for filtering out spam mails before they arrive at a recipient's computer. Upon receiving a mail, the filter checks an associated insignia, e.g. the e-mail address of the sender, and if the sender is not yet in the allowed list, a reply mail is generated for the sender. When the sender responds to the reply, a priority is assigned to the insignia and the firstly forwarded message is held back until the insignia is selected to the allowed list. The filter could be implemented in standard computer systems. The invention further provides a method of filtering messages.

### INTRODUCTION

The present invention relates to a filter for filtering electronic messages e.g. for discharging spam mail from an electronic mailing system. In particular, the invention relates to a filter for filtering electronic messages, said filter comprising:
storage space for an allowed list comprising identification insignias of senders which have been approved for sending messages to a recipient,
means for receiving a first electronic message from a sender,
means for capturing from the message an identification insignia of the sender,
means for capturing from the message an identification insignia of the recipient,
first check means for comparing the identification insignia with the allowed list for determining either to withhold the message or to forward the message to the recipient,
means for storing the message and insignia,
means for generating a return mail to the sender in case the identification insignia is not included in the allowed list, the means for returning the mail being adapted to include in the returned mail a unique code, and a message for the sender to reply to the return mall by sending it back without changing the unique code,
means for storing the unique code and relating it to the insignia, and
second check means for receiving a second electronic message and for recognising the second message being a reply to the returned mall.

Accordingly, the filter is of the kind wherein a sender's address is compared with a list of allowed addresses, and if the address is not contained therein, a reply is generated for the sender requesting completion of a registration process.

### BACKGROUND OF THE INVENTION

In parallel with the increasing growth of popularity of electronic mailing systems for exchanging information globally, the desire of reducing the number of received messages by automatically filtering out unwanted messages has increased. Spam mail, i.e. mail messages which are forwarded to a large number of unknown recipients e.g. with the purpose of advertising or in general for distributing information can slow down mail servers severely by occupying processor and storage resources, and, in worst case, the users may in annoyance over a large number of irrelevant messages overlook messages of importance.

Filters of the above described kind exist already. In U.S. Pat. No. 6,199,102 the prompt is designed to require manual operation whereby an automatic reply set up by a computer system, e.g. a computer system adapted for forwarding messages to a large group of recipients, are filtered out. The required manual operation could be a required response to a question, e.g. “what is the colour of the sky”, or “what is the current month”. In such a system, there is always a potential risk that persons of interest to the recipient get annoyed over the troubles, and e.g. after having given a wrong answer, e.g. by misspelling the colour of the sky, give up trying to reach the recipient.

### DESCRIPTION OF THE INVENTION

It is an object of the present invention to enable filtering of undesired mails from desired mails without requiring burdensome implication of the sending or the receiving part. Accordingly, the invention, in a first aspect, provides a filter of the above-mentioned kind, and further comprising: prioritising means which, in response to recognition of the second message being a reply to the returned mail, assigns a priority to each of the identification insignias of the senders of the first messages. The filter further comprising means for selecting identification insignias and adding the selected insignias to the allowed list, wherein the means for selecting are adapted to carry out the selection according to the priorities assigned to the identification insignias.

Since the user is not prompted for any specific answer but only is requested to push a “Reply” button, merely nothing should prevent a user from continuing an attempt to send a desired electronic message to a recipient. Moreover, those who, in spite of the requirement for replying to the message, attempts to send spam mail will not get directly through to the recipient. Instead, identification insignias of all replying senders are prioritised for further selection of insignias which will enter the allowed list. As a consequence of the prioritising, it is possible to do the final selection, e.g. manually without exercising an excessive work load.

The filter thus combines two separate filtering processes, and the combination provides a reduced number of received spam mails, and a reduced number of senders giving up an attempt to communicate a desirable message.

Often, electronic mail systems, work with multiple addresses (IP addresses). On some addresses they can send out messages and on other addresses they can receive messages. The addresses are listed in the so called dns entries. It may therefore be an advantage to provide in the filter, means for capturing from the message a list with multiple addresses from which the sender has access to send messages. If sender Q uses a mail system with 5 addresses, the filter should be able to obtain from this sender a list containing all 5 addresses. During the selection of insignias to be added to the allowed list, all 5 insignias should be added in one process step. In that way, it can be prevented that sender Q caused by an unsuspected use of another of the 5 addresses in a later attempt has to go through the complete acceptance procedure again.

Sometimes, electronic messages are communicated between large groups of people, i.e. one specific mail could be send to a plurality of recipients, and each recipient can choose a “Reply to All” command. In this case, acceptance of one person amongst a group of persons may advantageously imply an automatic acceptance of other people in that group. For that purpose, the filter may comprise means for generating a predict allowed list comprising identification insignias of third party mall recipients included by the sender in the first or the second electronic message. This list can be used in rule based selection methods by the prioritising means.

Normally, the prioritizing of the identification insignias eases the adding of insignias to the allowed list for the person in charge of this task. However, in one preferred embodiment, the filter may comprise a rule based selection method which, based on recognition of specific patterns in the prioritised insignias or mail content can select specific insignias directly for the allowed list without user intervention. As an example, such ruled based method could be adapted to enter all insignias except insignias containing a specific domain name, e.g. “hotmail” or similar “free of charge” domains. In another example, the rule based method could further be adapted to analyse the content of the message, e.g. for identifying a specific frequency of occurrence of one or more predetermined keywords in an electronic message. Accordingly, the following can exemplify the situation:

Person Q sending from the domain DOTCOMPANYNAME is not on the allow list but the message content contains a word recognised by the rule and therefore the insignia is added to the allow list and the mail is delivered to the recipient. As an example, the message may contain a word which indicates that the sender knows the recipient very well, e.g. the message may contain names or expression only being used within a narrow group of people. In another example, a message contains a word which removes the associated insignia from an allowed list, e.g. words which indicates that it could be a spam mail.

In a second aspect, the invention provides a method for filtering messages and in accordance with the features described for the first aspect of the invention.

### DETAILED DESCRIPTION OF THE INVENTION

In the following, the invention will be described in further details with reference to the drawing in which:

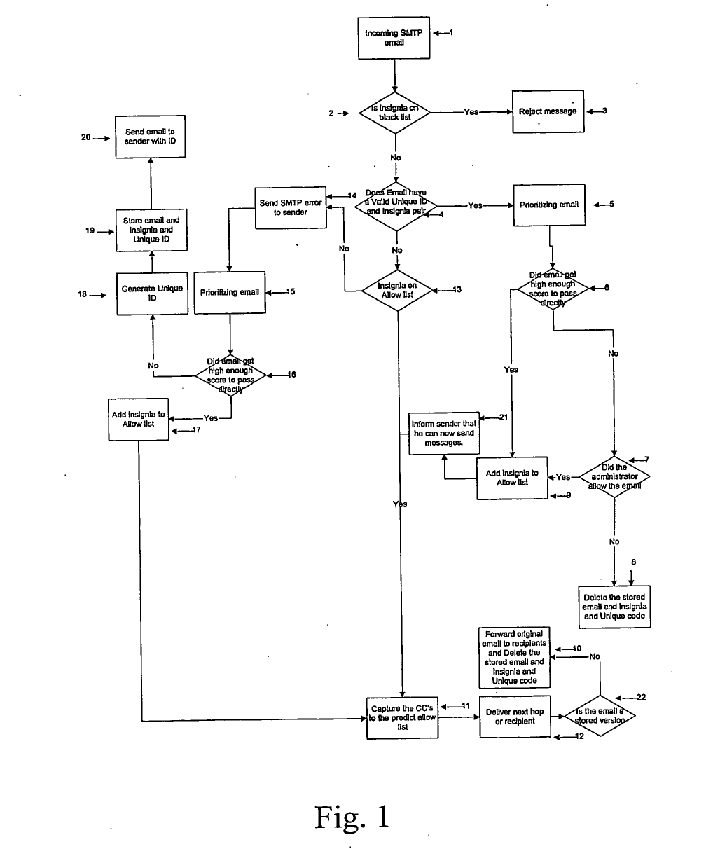

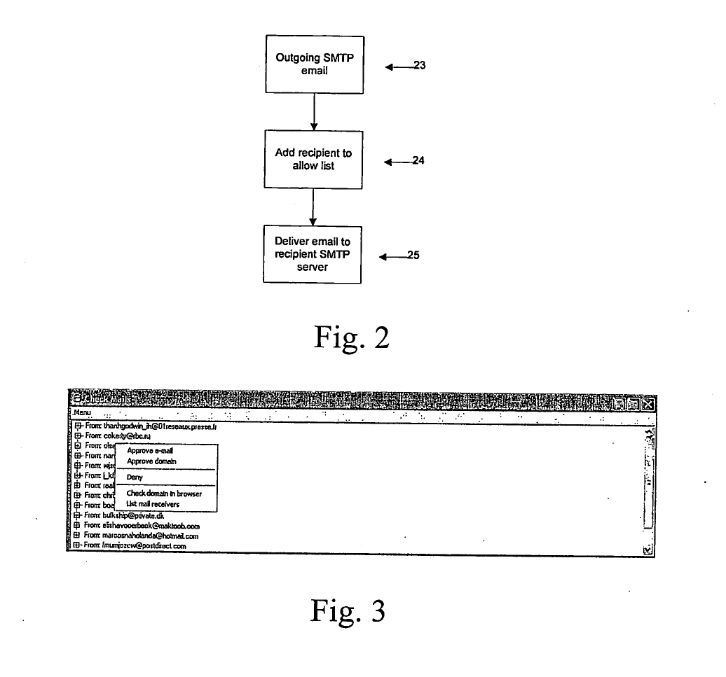

FIGS. 1 and 2 show a diagram of a software implemented filter for filtering spam messages from desired messages, and

FIG. 3 shows a screen dump from a computer implementation of the invention.

The following description is based on the implementation of the invention in a computer system for filtering e-mail messages. The implementation is done as a SMTP gateway but it could also have been implemented as a part of a messaging system (e.g. Microsoft Exchange server, Lotus Notes or Novell GroupWise). Reference is further made to the “Simple mail transfer protocol”, Jonathan B. Postel, RFC 821 of August 1982 from Information Sciences Institute, University of Southern California, Marina del Rey, Calif. and STANDARD FOR THE FORMAT OF ARPA INTERNET TEXT MESSAGES Aug. 13, 1982 Revised by David H. Crocker Dept. of Electrical Engineering University of Delaware, Newark, Del. 19711 Network: DCrocker @ UDel-Relay.

### Incoming Emails:

An email is received from the sender via the SMTP daemon on TCP port 25 (RFC 821) on the receiving server 1. The receiving server then extracts the sender insignia from the Mail From: on the SMTP protocol and the IP address of the sending server from the IP protocol 1. The receiving server then checks the insignia against the black list 2 if the insignia is included in the black list, the email is rejects and the sender's server is informed about this via an error message on the SMTP protocol 3.

If the insignia is not included in the black list the receiving server checks the subject line from the mime message (RFC 822, i.e. STANDARD FOR THE FORMAT OF ARPA INTERNET TEXT MESSAGES Aug. 13, 1982, Revised by David H. Crocker. www.faqs.org/rfcs/rfc822.html) for a unique code and compares this code and the insignia with the list of previously generated key pairs 4. If the incoming email does not contain a valid key pair the receiving server then checks if the insignia is on the allow list 13. If the insignia is not on the allow list the receiving server will send back a reply request to the sender by doing the steps described in the following text. The receiving server generates an error message on the SMTP protocol that informs the sending server that the email could not be received because the sender is not registered as a valid sender of mail to the receiver 14. After this step, the SMTP communication is either closed by the sending server or a new email is delivered to the receiving server. The receiving server then prioritizes the incoming email according to a given rule set and assigns a priority value to the email message 15. If the assigned value is not exceeding a given threshold value a Unique ID is generated by the receiving system 18. The incoming email, insignia and Unique ID is then stored by the receiving server for later retrieval 19. The receiving server sends an email to the sender of the incoming email asking to reply to it without changing the subject line of the mime message (RFC 822) 20.

If the incoming email did get a priority value exceeding the given threshold value 16 the insignia of the sender is added to the allow list 17.

If the incoming email sender insignia was on the allow list 13 then the receiving server captures the CC: from the mime message and stores them the predict allow list for later retrieval 11. The email is then delivered to the recipient mall box or forwarded to the next step 12.

If the email did contain a valid key pair 4 the receiving server will prioritize the email message and assign it a priority value 5. If the assigned value is not exceeding a given threshold the choice of allowing the email is up to the administrator 7. If the email is not approved by the administrator the original message, unique ID and insignia is deleted from storage space 8. If the email is approved by the administrator or had a priority value exceeding the threshold 6 the insignia is added to the allow list 9. The receiving system then informs the sender by sending an email that he can now send emails to the recipient and that the previously sent email will be delivered 21. The receiving system captures the CC: from the mime message and stores them in the predict allow list for later retrieval 11.

The email is then delivered to the recipient mail box or forwarded to the next hop 12. Then the receiving system deletes the Email, insignia and unique ID from storage 10.

### Outgoing Emails:

An email is received from the sender via the SMTP daemon on TCP port 25 (RFC 821) on the server 23 from an internal sender. The server adds the insignia of the recipient/recipients captured from the SMTP rcpt to: (RFC 821) on the Allow list 24. The email is delivered to the recipients SMTP via TCP port 25 (RFC 821) 25.

### Description of Technical Terms in One Specific Implementation of the Invention:

The simplest form of an insignia is an email address or the domain part of the sender's email address. More complex insignias can include an email address with or without a list of IP addresses from which a user can send. Alternatively, the insignia may include a domain with or without a list for IP addresses from which the user from that domain can send.

The domain part could be defined as the sub string starting after the ‘@’ sign and ending at the end of the email address including the last character.

The storage space could be defined as space on a harddisk or space on a set of harddisks (Raid set) in which the insignias are stored as records on the insignia list (allow list and predict allow list). An allow list can in the simplest form consists of only sender insignias or more complex to allow fine grained control by making a list that includes a relationship between a sender insignia and a recipient insignia.

The system is connected to the Internet and running a SMTP daemon on TCP port 25 from which it can receive incoming messages from senders connected to the same net.

Using the SMTP protocol specified in RFC 821 the system captures the sender's email address, i.e. an identification insignia from the mail from: command. Further the system captures the sender's IP address from the TCP layer. By use of the SMTP protocol specified in RFC 821 the system captures the sender's email address insignia from the rcpt to: command.

The system compares the sender insignia with the insignias stored in the allow list using the same type of insignia record (simple or complex) as defined by the allow list record for a specific record.

The Message and the insignia could be stored in a space on a harddisk or in a space on a set of harddisks (Raid set) in which the message and insignia is stored for later retrieval.

If the identification insignia is not included in the allowed list, a return mail to the sender is generated in program memory and send to the sender via the STMP daemon using TCP PORT 25. This return message subject field (RFC 822) includes a 128 bit value code converted to a string plus a word that can be scanned for in the incoming email messages (e.g. ID=C4389FBD-0872-4077-8FFF-0001901F1D89). The code is generated by making a random 128 bit number and then converting it to a string. Subsequently, the unique code and a relation between the insignia are stored as a key pair in a space on a harddisk or space on a set of harddisks (Raid set). The insignia is stored with a pointer to the code for later retrieval.

Capturing the unique ID can be done by scanning the incoming email messages subject field (RFC 822) for a word (e.g. ID=) and then capturing the substring containing the next 19 characters after the ID=.

Checking the validity for an incoming unique id and insignia can be done by matching up the key pair represented by these two values and the key pair list generated by the first message.

Prioritizing the message can be done by having static or dynamic lists of words, email addresses (predicts allow list) and/or domains which is assigned a weight value stored in a space on a harddisk or in a space on a set of harddisks (Raid set). The entities in the list are then compared to the content of the message and insignias word by word or insignia by insignia. A value equal to the sum of the weights values for all matches is attached to the message as a priority value.

The choice of allowing the message could be up to the administrator. For this purpose a GUI is designed to display the needed information for the administrator to make the choice in a list sorted by the priority value—the higher the value the more important the message is. The GUI in question is shown in FIG. 3.

An Internal sender can be detected by using the sender's IP address and matching it to a list consisting of predetermine address IP for internal sender. The list could be stored as records in a database on a space on a harddisk or in a space on a set of harddisks (Raid set).

1. A filter for filtering electronic messages, said filter comprising:
storage space for an allowed list comprising identification insignias of senders which have been approved for sending messages to a recipient,
means for receiving a first electronic message from a sender,
means for capturing from the message an identification insignia of the sender,
means for capturing from the message an identification insignia of the recipient,
first check means for comparing the identification insignia with the allowed list for determining either to withhold the message or to forward the message to the recipient,
means for storing the message and insignia,
means for generating a return message to the sender in case the identification insignia is not included in the allowed list, the means for returning the message being adapted to include in the returned message a unique code, and a message for the sender to reply to the returned message by sending it back without changing the unique code,
means for storing the unique code and relating it to the insignia, and
second check means for receiving a second electronic message and for recognizing the second message being a reply to the returned message, wherein the filter further comprises:
prioritizing means which, in response to recognition of the second message being a reply to the returned message, assigns a priority to each of the identification insignias of the senders of the first messages, and
means for selecting identification insignias and adding the selected insignias to the allowed list, wherein the means for selecting are adapted to carry out the selection according to the priorities assigned to the identification insignias.

2. A filter according to claim 1, wherein the second check means performs the recognition by:
capturing in the second message the unique code, and a second identification insignia of the sender of the second message, and
checking that the unique code has not changed, and that the second identification insignia corresponds to the first identification insignia.

3. A filter according to claim 1, further comprising means for capturing from a server a list comprising at least one address from which the sender has access to send messages from.

4. A filter according to claim 3, further comprising means for checking that the sender is sending from an address included in the list.

5. A filter according to claim 1, further comprising means for generating a predict allowed list comprising identification insignias of third party message recipients included by the sender in the first or the second electronic message.

6. A filter according to claim 1, further comprising rule based selection means which, based on recognition of a specific pattern in the content of the message sets the priority of the identification insignias.

7. A filter according to claim 1, further comprising means for automatically selection of insignias with priorities above a predetermined value for the allowed list.

8. A filter according to claim 1, wherein the identification insignias of the senders and the data identifying the sender include at least a domain identification of the sender's electronic mail address.

9. A filter according to claim 1, further comprising means for withholding the electronic message from final delivery to the intended recipient until an administrator has accepted delivery of the message to the recipient, the administrator being one of a human administrator, a software-implemented administrator, and the recipient of the message.

10. A filter according to claim 1, further comprising storage for a black-list, and means for checking occurrence of an identification insignia in the black-list prior to comparing the identification insignia with the allowed list.

11. A filter according to claim 1, comprising means for communicating, in an SMTP message, and in response to receiving the message from a sender with an insignia not included in the allowed list or optionally, with an insignia included in the black-list, that the message could not be delivered to the recipient.

12. A filter according to claim 11, comprising counting means for counting a number of reoccurrences of identical messages being received, and for adding the insignia of the sender of such messages which reoccur more than a pre-specified number of times to the black-list.

13. A filter according to claim 1, comprising means for adding to the allowed list, insignias of potential senders to whom the recipient has previously been sending messages.

14. A filter according to claim 1, comprising means for measuring a frequency of messages to and from a specific sender, and upon detection of frequencies above a pre-specified level, for forwarding the first message to the recipient irrespective if the insignia of the sender is not in the allowed list.

15. A filter according to claim 1, wherein the means for generating a return message to the sender is adapted to send the return message by use of an identification insignia corresponding to the identification insignia of the intended recipient of the first message.

16. A method for filtering electronic messages, said method comprising the steps of:
assigning space in a computer system for a list comprising identification insignias of senders which have been approved for sending messages to a recipient,
receiving a first electronic message from a sender,
capturing from the message an identification insignia of the sender,
capturing from the message an identification insignia of the recipient,
comparing the identification insignia with the allowed list for determining either to withhold the message or to forward the message to the recipient,
storing the message and insignia in a storage space of the computer system,
generating a return message to the sender in case the identification insignia is not included in the allowed list, and including in the returned message a unique code, and a message for the sender to reply to the return message by sending it back without changing the unique code,
storing the unique code and relating it to the insignia, and
receiving a second electronic message and recognizing the second message being a reply to the returned message,
wherein the method comprises the steps of:
in response to recognition of the second message being a reply to the returned message, assigning a priority to each of the identification insignias of the senders of the first messages, and
selecting identification insignias and adding the selected insignias to the allowed list, wherein the selecting is carried according to the priorities assigned to the identification insignias.
